(19) United States
(12) Patent Application Publication
(10) Pub. No.: US 2013/0022226 A1
(43) Pub. Date: Jan. 24, 2013

(54) EARBUD SET HAVING INTEGRATED EARPHONES AND PROTECTIVE DECORATIVE COVERING

(71) Applicant: Sharon A. ANDERSON, St. Petersburg, FL (US)

(72) Inventor: Sharon A. ANDERSON, St. Petersburg, FL (US)

(21) Appl. No.: 13/185,131

(22) Filed: Jul. 18, 2011

(51) Int. Cl. H04R 1/10

(52) U.S. Cl. 381/380

(57) ABSTRACT

The invention relates to earphones, also known as earbuds, which are used to listen to music or other types of information produced by audio equipment such as MP3 players, CD players, laptops, cell phones and so on. According to the invention, an earphone set is integrated with a protective and decorative covering. The earphone set which has a cable connecting left and right speakers which are to be inserted in to a user's ears, and a connector plug to an audio device. The cable has left and right branches which lead to the speakers, respectively, and a tail which leads to the connector plug. The protective, decorative covering is embodied as a “Y” shaped sleeve of material which covers the cable from the speakers to the connector plug, thereby completely encasing the cable, while allowing the speakers and the connector plug to be exposed.

### CROSS-REFERENCE TO RELATED APPLICATION

This application is based on U.S. Design Ser. No. 29/370,212 filed Jul. 16, 2010.

### BACKGROUND OF THE INVENTION

1. Field of the Invention

The invention relates to earphones, also known as earbuds, which are used to listen to music or other types of information produced by audio equipment such as MP3 players, CD players, laptops, cell phones and so on.

2. Description of the Prior Art

Conventional earphones in recent years have become available in an array of fashionable colors allowing the user of the earphones to express their individual tastes and make a fashion statement. In such earphones a plastic encasement for the earphone wiring which extends from a connector plug for an audio player at one end and splits into two branches which end in left and right earphones speakers which are inserted into a user's ears.

Conventional earphones cables are typically provided with the two ends having the earphone speakers, and a tail to the connector plug which become entangled and knotted when not in use. Consequently, earphone users have found conventional devices to be frustrating when the earphone cable becomes entangled. Untangling the earphone cables is quite cumbersome. Accordingly, there is a need for earphones that do not become entangled when in storage.

### SUMMARY OF THE INVENTION

In an illustrative, non-limiting implementation, earphones/earbuds are provided for listening to music or other types of information produced by audio equipment such as MP3 players, CD players, and so on. The cables of the earphones or earbuds are integrated with a protective and decorative covering or sleeve, according to the taste of the user, which personalized the user's earbuds.

According to the invention, the decorative sleeve, which personalizes the earbuds, is intended to be a fashion statement, but advantageously keeps the earbud cables tangle free.

A feature provided by the earphone cable in conjunction with the sleeve is that the two are of such material that the cable and sleeve do not become bound upon one another. The material of the sleeve prevents entanglement of the cable branches and tail.

The earbuds sleeve is a material custom fit and sewn and/or glued to fit completely over the earbuds cable thereby encasing it and having openings at the three ends of the earbuds cable, two openings for the earphone speakers that go into the ears at the end of the cable branches, and a third opening for the connector plug that inserts into the music player at the end of the cable tail.

One aspect of the invention provides that the protective, decorative covering is embodied as a “Y” shaped sleeve of material which covers the cable along the left and right branches thereof from the speakers down the tail to the connector plug. The sleeve provided with the openings for the speakers and the connector plug, thereby completely encases the cable, while allowing the speakers and the connector plug to be exposed.

The earbud set according to the invention provides for the openings in the sleeve to be attached to the speakers and the connector plug respectively by an adhesive.

According to another feature of the invention, the sleeve in an “unrolled” state, prior to encasing the cable, has two sleeve branch sections and a sleeve tail section, which correspond to the branches and tail of the cable, respectively. The lengthwise edge areas of the two sleeve branch sections and of the sleeve tail section are sewn together with stitches. Alternatively, the lengthwise edge areas of the two sleeve branch sections and of the sleeve tail section are glued together with an adhesive.

It is advantageous that after the two sleeve branch sections and the sleeve tail section have been assembled around the earbud cables, a hard plastic housing which can be embodied in the shape of a cylinder, is attached around the “Y” intersection of the branches and the tail of the sleeve. The housing is used to secure the sleeve material at the “Y” intersection. Furthermore, the housing has an aesthetic appeal, i.e., it covers or hides any imperfections in the attachment of the sleeve material to the earbud cable, such as exposed threads or excess glue.

Similarly to the hard plastic housing provided at the “Y” intersection, likewise another housing can be provided at the end of the sleeve tail section at the connector plug. In this case, the housing would hide any unsightly end of the sleeve material attached to the earbud cable at the connector plug.

The housings for the “Y” intersection and the earbud tail end can be formed by injection molding and then press fit onto the sleeve in the desired location. A variety of shapes for the housings are possible. This also includes an embodiment for attachment of a cover over the attached sleeve at the earphone speakers.

The invention provides that the covering is a material of made of cotton, leather, pleather, Mylar®, faux fur, suede, plaid, corduroy, carbon fiber, sequin, beaded, rubber, or knitted or crocheted yarn or thread.

Advantageously, the personalized earbud set comes packaged with the earbuds ready to plug in with the integrated sleeve designed with a flashy material, or decorative print, favorite team colors, corporate logos, airlines, sports teams, school names, and other indicia for example. Uniquely, the earbud set is already assembled and ready to plug in and go. Nothing additional is required when the earbud set is purchased by a consumer.

### BRIEF DESCRIPTION OF THE DRAWINGS

The preferred embodiments of the invention are described in detail below in conjunction with the accompanying drawings, in which:

FIG. 1 illustrates an embodiment of the earbud set as provided by the present invention, showing an earphone set integrated with protective and decorative covering;

FIG. 2 shows earbud set of FIG. 1, showing the earbud cables being assembled with the cover;

FIG. 3 shows a perspective view of an earphone set integrated with protective and decorative covering, featuring an outer housing at different attachment points of the earphone cable and the cover; and

FIG. 4 shows a variety of embodiments of outer housings.

### DETAILED DESCRIPTION OF PREFERRED EMBODIMENTS

The following description of the illustrative, non-limiting embodiment of the invention discloses specific configurations and components. However, the embodiments are merely examples of the present invention; and thus, the specific features described below are used to describe more easily such embodiments and to provide an overall understanding of the present invention. Accordingly, a skilled artisan will readily recognize that the present invention is not limited to the specific embodiments described below. Furthermore, the descriptions of various configurations and components of the present invention that are known to the ordinarily skilled artisan are omitted for the sake of clarity and brevity.

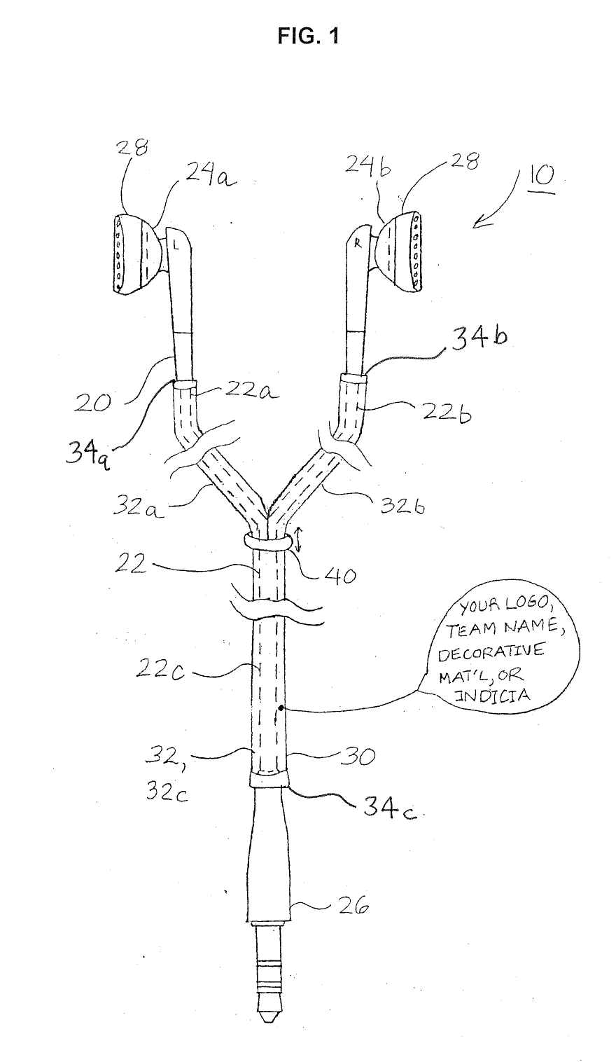

FIG. 1 illustrates an embodiment of the earbud set as provided by the present invention, showing an earphone set integrated with a protective and decorative covering.

FIG. 1 shows an illustrative, exemplary embodiment of the present invention of an earbud set 10. The earbud set 10 includes an earphone set 20, and a protective, decorative cover 30. The earphone set 20 has an earbud cable or cord 22, a left earphone speaker 24a, a right earphone speaker 24b, and connector plug 26. The earbud cord 22 has left and right separate branches 22a, 22b which lead to the earphone speakers 24a, 24b, respectively, and a tail 22c which leads to the connector plug 26. It should be noted that the earbud cord 22 is a simple earbud cord, in that none of the branches and tail are detachable or disconnectable from one another in any manner other than a destructive manner.

The left earphone speaker 24a and right earphone speaker 24b are designed to be inserted into one's ears to listen to music or other audible information produced by audio equipment such as MP3 players, CD and DVD players, cell phones, and so on (not shown). The left and right earphone speakers 24a, 24b may include ear caps 28 made of silicon, rubber or other soft material for comfortable wearing by a user.

Each of the branches 22a, 22b of the earbud cord 22 has speaker wires contained in a grounding mesh or other insulative shielding (not shown for sake of simplicity) covered by a plastic, cloth, or rubber outer layer, shown in hidden lines in FIG. 1. The earphone speakers are each connected to conductive wires and a shielding mesh/ground conductor in the left and right earphone speakers. The two conductive wires and shielding mesh/ground conductor being provided in the earbud cord 22 as one of ordinary skill in the art would understand, to help prevent interference from electromagnetic interference or electromagnetic disturbance.

Covering the earbud cord 22 is the protective, decorative cover 30 according to the invention is shown, which is embodied as a sleeve 32 of material which extends from the left and right branches 22a, 22b of the earbud cord 22 from the earphone speakers 24a, 24b down the tail 22c of the earbud cord 22 to the connector plug 26. At each of the two branch ends and at the tail end of the sleeve 32, openings 34a, 34b, 34c are provided for the earphone speakers 24a, 24b and the connector plug 26, respectively, allowing them to be exposed.

The sleeve 32 of material is custom fitted and sewn to fit completely over earbud cord 22 thereby encasing it and leaving the openings 34a, 34b at the ends of the sleeve 32 for the earphone speakers 24a, 24b that go into the ears and an opening 34c for the connector plug 26 that inserts into the music player. The material that is custom fitted over earbud cord 22 typically is 41-42 inches long and ¼-½ inches wide, but the measurements can be varied to accommodate different sizes of earbud sets. It is noted that the earbud set 10 shown in FIG. 1 is shown with breaks in the figure, which indicate that additional lengths of the branches and tail of the earbud set are omitted for simplicity.

A slider 40 may also be provided which is enabled to articulate between the right and left earphone speakers 24a, 24b over the left and right branches 22a, 22b of the earbud cord 22 to the junction with the tail 22c. The slider 40 is provided over the cover 30 which shortens or lengthens the distance between a junction of the separate branch section 32a, 32b of the earbud set 10, and the earphone speakers 24a, 24b, according to the specification of the wearer. An arrow indicated that the slider 40 can be raised or lowered along the exterior of the sleeve 32.

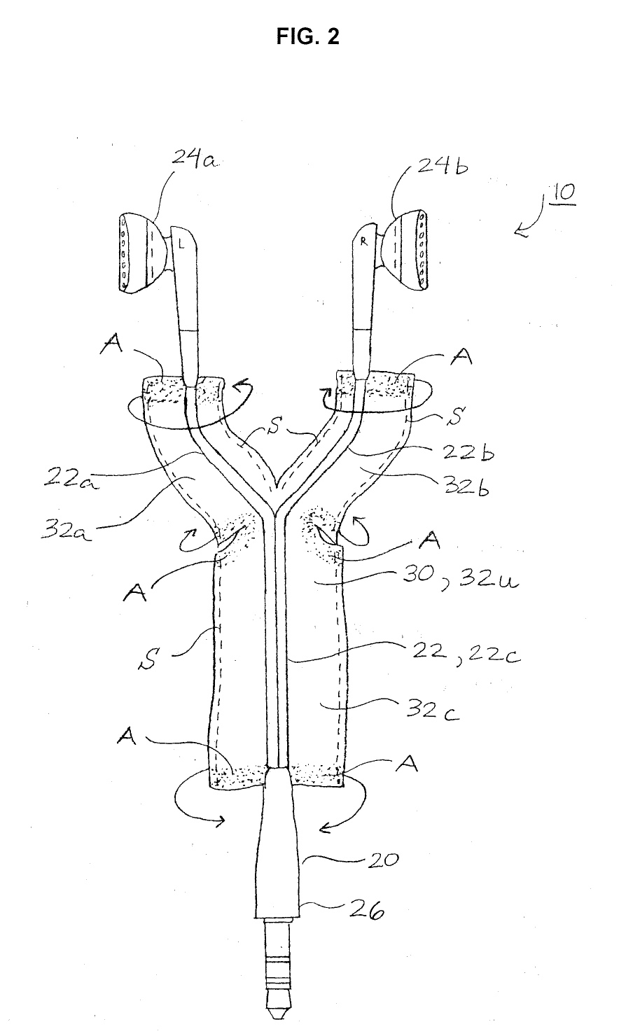

Referring now also to FIG. 2, the assembly of the earbud set 10 according to the invention is described hereinafter. It is noted that unlike FIG. 1, no breaks are shown in the figure and as such it will be understood that FIG. 2 is not dimensioned to scale, for clarity and simplicity.

FIG. 2. shows the earbud set 10 according to the invention, during an assembly stage of the earphone set 20 being integrated with the protective, decorative cover 30. The earphone set 20 is shown with the earbud cord 22 drawn with solid lines, as the cover 30 does not yet encase the earbud cord 22 as in FIG. 1. Here the cover 30 is embodied as the sleeve 32u is shown in an “unrolled” state, which means the sleeve 32u has not yet been sewn and/or glued around the earbud cord 22. The material of the unrolled sleeve 32u is shown having two branch sections 32a, 32b and a tail section 32c, which correspond to the branches 22a, 22b and tail 22c of the earbud cord 22, respectively. Arrows are provided for illustrated purposes, which indicate an example of how the covering material of the sleeve 32u can be wrapped around the earbud cord branches 22a, 22b and tail 22c. Upper and lower end areas of the covering material of the sleeve 32u which correspond to upper and lower ends of the braches and tail of the earbud cord are shown having an adhesive, as indicated with the appropriate legend for an adhesive, and with the letter “A.” Additionally, the edge areas of the covering material of the sleeve 32u are shown with dashed lines and labeled with the letter “S” which represents the areas which could be sewn with stitches rather than glued, although gluing is also an alternative.

The covering material of the sleeve 32u can be sewn into a sleeve 32 configured are a “Y” shape (see FIG. 1) to accommodate the earphone set 20 as a first step, say for example while the material is inside out so that the stitching S does not show when the sleeve 32 is turned right side out. Then the sleeve 32 can be slid over the earphone speakers 24a, 24b from the opening at the end of the tail section 32c of the sleeve, while “threading” the earbud cable branches 22a, 22b into the respective branch sections 32a, 32b of the sleeve 32. Then the loose open ends of the “Y” shaped sleeve 32 are glued at the appropriate places A to secure the sleeve 32 to the earbud cord 22 as shown in FIG. 1. It will be understood that the assembly method of the earbud set can be achieved in alternative manners. The combined end result of the earbud set 10 having the earphone set 20 integrated with the protective, decorative cover 30, is achieved by surrounding the existing earphone set with the cover, resulting in the present invention.

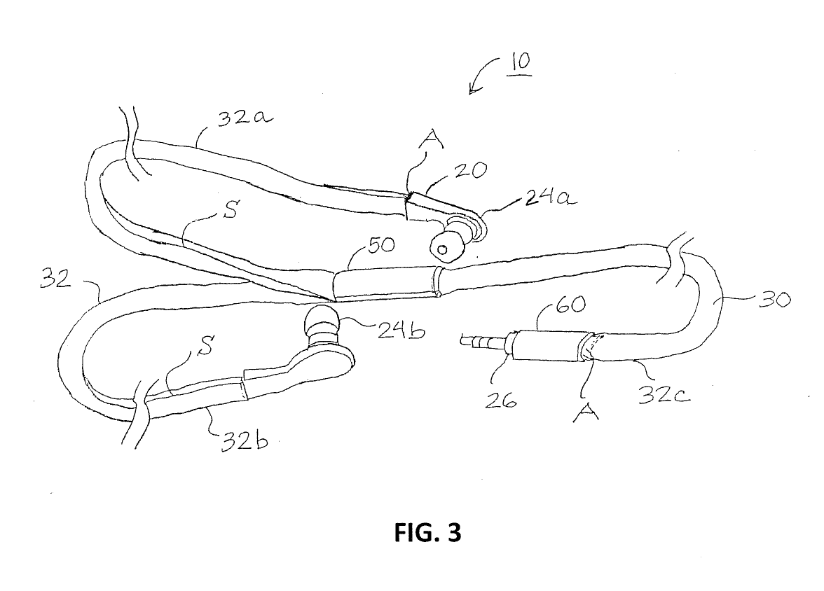

Referring now to FIG. 3, a perspective view of an earbud set 10 of an earphone set 20 integrated with protective and decorative covering 30, is shown in an assembled state. An additional feature is shown of an outer hard cover 50 located at different attachment points of the earbud cord 22 (not visible in FIG. 3) and the cover 30. After the two branch sections 32a, 32b and the tail section 32c of the sleeve 32 have been assembled around the earbud cord 22, an outer housing 50, which can be embodied in the shape of a tube in FIG. 3, is attached around the “Y” intersection of the branch sections 32a, 32b and the tail section 32c of the cover 30. The outer housing 50 is used to additionally secure the sleeve material at the “Y” intersection after the assembly of the 32u and earbud cord 22 (FIG. 2). Furthermore, the outer housing 50 has an aesthetic appeal, i.e., it covers or hides any imperfections in the attachment of the material of the cover 30 to the earbud cable, such as exposed threads or excess glue.

Similarly to the outer housing 50 provided at the “Y” intersection, another outer housing 60 can be provided at the end of the tail section 32c where the cover is attached at the connector plug 26. The outer cover 60 in this case would hide any unsightly end of the cover material attached to the earbud cable 22 at the connector plug 26. The outer housings 50, 60 for the “Y” intersection and the earbud tail end, respectively, can be formed by injection molding for example, and then press fit onto the sleeve in the desired location. This also includes an embodiment for attachment of an outer housing over the cover 30 attached to the earbud cord 22 at the earphone speakers 24a, 24b (not shown).

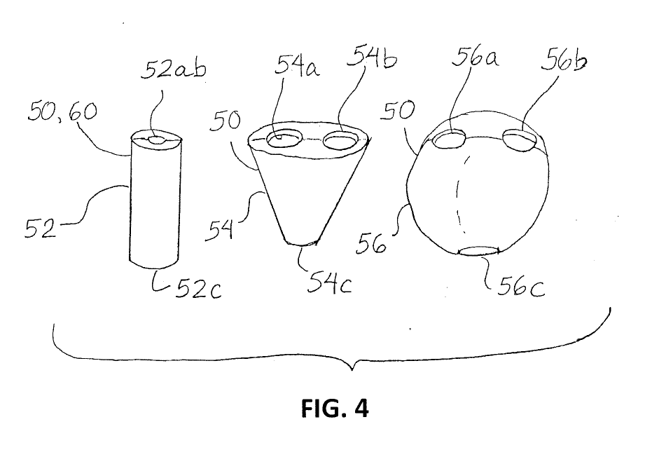

Referring now to FIG. 4, a variety of embodiments of outer housings is shown. A first embodiment of the outer housing 50, 60 for the “Y” intersection or for the end of the tail section 32c, is shaped as a tube 52, as depicted in FIG. 3, having one opening 52ab for both the branch section 32a, 32b and one opening 52c for the tail section 32c. A second embodiment of the outer housing 50 is shown as an oblong cone 54, having two openings 54a, 54b for the two branch sections 32a, 32b and one opening 52c for the tail section 32c. A third embodiment is shown as a sphere 56 having two openings 56a, 56b for the branch sections 32a, 32b and one opening 56c for the tail section 32c. These outer housing 52, 54, 56, keeping in line with the decorative aspect of the invention, can be a variety of colors, or include printed indicia as well.

It is also conceivable that the outer housing 50 can function as a slider (element 40, described above) which is provided over the sleeve 32 which shortens or lengthens the distance between a junction of the separate branch section 32a, 32b of the earbud set 10, and the earphone speakers 24a, 24b, according to the specification of the wearer.

It should be appreciated that the novelty in the invention also lies in that the earbud set 10 comes packaged for sale as described, as a preassembled, integrated product.

The following is a list of possible materials that the earbud sleeve 32 could be created from, including: cotton, leather, pleather, Mylar, faux fur, suede, plaid, corduroy, carbon fiber, sequin, and knitted or crocheted yarn or thread. The material can also be printed with indicia, such as a company logo, team or school name. The possibilities are endless, and according to the material selected for the cover, a method for assembly can be adapted accordingly.

It will thus be seen that the embodiments set forth above and those made apparent from the preceding description are efficiently attained and since certain changes may be made in the above construction without departing from the scope of the invention, it is intended that all matter contained in the above description or shown in the accompanying drawings shall be interpreted as illustrative and not in a limiting sense. It is also to be understood that the following claims were intended to cover all of the generic and specific configurations of the invention herein described and all statements of the scope of the invention that as a matter of language might be said to fall therebetween.

I claim:

1. An earbud set (10), which is used to listen to music or other types audio information produced by an audio device, having an earphone set integrated with a protective and decorative covering, comprising:
an earphone set (20) which has a cable (22) connecting left and right speakers (24a, 24b) to be inserted in to a user's ears, and a connector plug (26) to an audio device, the cable (22) having left and right branches (22a, 22b) which lead to the speakers (24a, 24b), respectively, and a tail (22c) which leads to the connector plug (26); and
a protective, decorative covering (30) embodied as a “Y” shaped sleeve (32) of material which covers the cable (22) along the left and right branches (22a, 22b) from the speakers (24a, 22b) down the tail (22c) to the connector plug (26), the sleeve (32) being provided with openings (34a, 34b, 34c) for the speakers (24a, 24b) and the connector plug (26), at an end of each part of the “Y” shaped sleeve (32), respectively, thereby completely encasing the cable (22), while allowing the speakers (24a, 24b) and the connector plug (26) to be exposed.

2. The earbud set according to claim 1, wherein the “Y” shaped sleeve is attached to the speakers and to the connector plug at the openings in the sleeve for the speakers and for the connector plug, respectively.

3. The earbud set according to claim 2, wherein the openings in the sleeve are attached to the speakers and the connector plug respectively by an adhesive.

4. The earbud set according to claim 1, wherein the sleeve (32u) in an “unrolled” state, prior to encasing the cable, has two sleeve branch sections (32a, 32b) and a sleeve tail section (32c), which correspond to the branches (22a, 22b) and tail (22c) of the cable (22), respectively.

5. The earbud set according to claim 4, wherein lengthwise edge areas of the two sleeve branch sections and of the sleeve tail section are sewn together with stitches.

6. The earbud set according to claim 4, wherein lengthwise edge areas of the two sleeve branch sections and of the sleeve tail section are glued together with an adhesive.

7. The earbud set according to claim 1, wherein the covering is printed with indicia, such as a company logo, team, or school name.

8. The earbud set according to claim 1, wherein the covering is a material of made of cotton, leather, pleather, Mylar, faux fur, suede, plaid, corduroy, carbon fiber, sequin, beaded, rubber, or knitted or crocheted yarn or thread.

9. The earbud set according to claim 1, wherein the cable and the sleeve are made of materials such that the cable and sleeve do not become bound upon one another and entanglement of the branches and tail of the cable is prevented.

10. The earbud set according to claim 4, wherein an outer housing (50) is provided over the sleeve (32) in an assembled state with the cable at an intersection of the two sleeve branch sections (32a, 32b) and the sleeve tail section (32c).

11. The earbud set according to claim 5, wherein an outer housing is provided over the sleeve (32) in an assembled state with the cable at an intersection of the two sleeve branch sections (32a, 32b) and the sleeve tail section (32c).

12. The earbud set according to claim 6, wherein an outer housing is provided over the sleeve (32) in an assembled state with the cable, at an intersection of the two sleeve branch sections (32a, 32b) and the sleeve tail section (32c), thereby encasing the intersection.

13. The earbud set according to claim 10, wherein the outer housing is embodied as a tube having one opening for both the branch section and one opening for the tail section.

14. The earbud set according to claim 10, wherein the outer housing is embodied as an oblong cone having two openings for the two branch sections and one opening for the tail section.

15. The earbud set according to claim 10, wherein the outer housing is embodied as a sphere having two openings for the branch sections of the sleeve and one opening for the tail section.
